(19) United States
(12) Patent Application Publication
(10) Pub. No.: US 2015/0294326 A1
(43) Pub. Date: Oct. 15, 2015

(54) GENERATING APPARATUS, SELECTING APPARATUS, GENERATION METHOD, SELECTION METHOD AND PROGRAM

(71) Applicant: International Business Machines Corporation, Armonk, NY (US)

(72) Inventor: Takayuki Osogami, Tokyo (JP)

(21) Appl. No.: 14/748,265

(22) Filed: Jun. 24, 2015

Related U.S. Application Data
(63) Continuation of application No. 14/633,404, filed on Feb. 27, 2015.

(30) Foreign Application Priority Data
Mar. 14, 2014 (JP) 2014-052153

(51) Int. Cl. G06Q 30/02; G06Q 10/04

(52) U.S. Cl. CPC G06Q 30/0201; G06Q 10/04

(57) ABSTRACT

A generating apparatus is arranged to generate a set of gain vectors with respect to a transition model having observable visible states and unobservable hidden states and expressing a transition from a present visible state to a subsequent visible state according to an action, the set of gain vectors being generated for each visible state and used for calculation of a cumulative expected gain at and after a reference point in time. The apparatus includes a generation section for recursively generating, by retroacting from a future point in time to the reference point in time, a set of gain vectors containing at least one gain vector including a component of a cumulative expected gain with respect to each hidden state, from which set of gain vectors the gain vector giving the maximum of the cumulative expected gain is to be selected.

This application is a continuation of U.S. patent application Ser. No. 14/633,404, filed Feb. 27, 2015, which claims priority to Japanese Patent Application No. 2014-052153, filed Mar. 14, 2014, and all the benefits accruing therefrom under 35 U.S.C. §119, the contents of which in its entirety are herein incorporated by reference.

### BACKGROUND

The present invention relates to a generating apparatus, a selecting apparatus, a generation method, a selection method and a program.

Sequential decision making in an environment including unobservable states has been formulated as a partially observable Markov decision process (POMDP) (Patent Literatures 1 to 3). In some decision making problems, observability and invariability of states are known, for example, part of the states are completely observable while the other parts are unobservable. Also, in some cases, an unobservable part is invariable. Conventionally, in such a case, an optimum policy is calculated by a general-purpose POMDP solver.

Patent Literature 1—JP2011-53735A

Patent Literature 2—JP2012-123529A

Patent Literature 3—JP2012-190062A

### SUMMARY

Exemplary embodiments calculate at a high speed an optimum policy in a transition model having completely observable visible states and unobservable hidden states.

According to a first aspect of the present invention, there is provided a generating apparatus arranged to generate a set of gain vectors with respect to a transition model having observable visible states and unobservable hidden states and expressing a transition from a present visible state to a subsequent visible state according to an action, the set of gain vectors being generated for each visible state and used for calculation of a cumulative expected gain at and after a reference point in time, the apparatus including a generation section for recursively generating, by retroacting from a future point in time to the reference point in time, a set of gain vectors containing at least one gain vector including a component of a cumulative expected gain with respect to each hidden state, from which set of gain vectors the gain vector giving the maximum of the cumulative expected gain is to be selected, a generation method using the generating apparatus, and a program.

According to a second aspect of the present invention, there is provided a selecting apparatus arranged to select an optimum action in a transition model having observable visible states and unobservable hidden states and expressing a transition from a present visible state to a subsequent visible state according to an action, the apparatus including an acquisition section for obtaining, with respect to each visible state, a set of gain vectors containing at least one gain vector including a component of a cumulative expected gain with respect to each hidden state and used for calculation of a cumulative expected gain at and after a reference point in time, a gain selection section for selecting, from the gain vectors according to the present visible state, the gain vector maximizing the cumulative expected gain with respect to a probability distribution over the hidden states at the present point in time, and an action selection section for selecting an action corresponding to the selected gain vector as an optimum action, a selection method using the selecting apparatus, and a program.

### BRIEF DESCRIPTION OF THE DRAWINGS

FIG. 1 illustrates an outline of an information processing system according to an exemplary embodiment;

FIG. 2 illustrates an example of a visible state, s and a hidden state b according to an exemplary embodiment;

FIG. 3 illustrates a processing flow in a generating apparatus 10 according to an exemplary embodiment;

FIG. 4 illustrates an example of a method for generating a set Λₙ(s) with a generation section in an exemplary embodiment;

FIG. 5 illustrates an example of a concrete algorithm for the processing flow in FIG. 3;

FIGS. 6(a) and 6(b) illustrate the relationship between a set Λ_{s,n} and a cumulative expected gain;

FIG. 7 illustrates another example of a concrete algorithm for the processing flow in FIG. 3;

FIG. 8 illustrates a processing flow in a selecting apparatus according to an exemplary embodiment; and

FIG. 9 illustrates an example of a hardware configuration of a computer.

### DETAILED DESCRIPTION

The present invention will be described with respect to an embodiment(s) thereof. However, the invention according to the appended claims is not limited to the embodiment described below. Also, not all of possible combinations of features described in the embodiment are indispensable to the solving means according to the present invention.

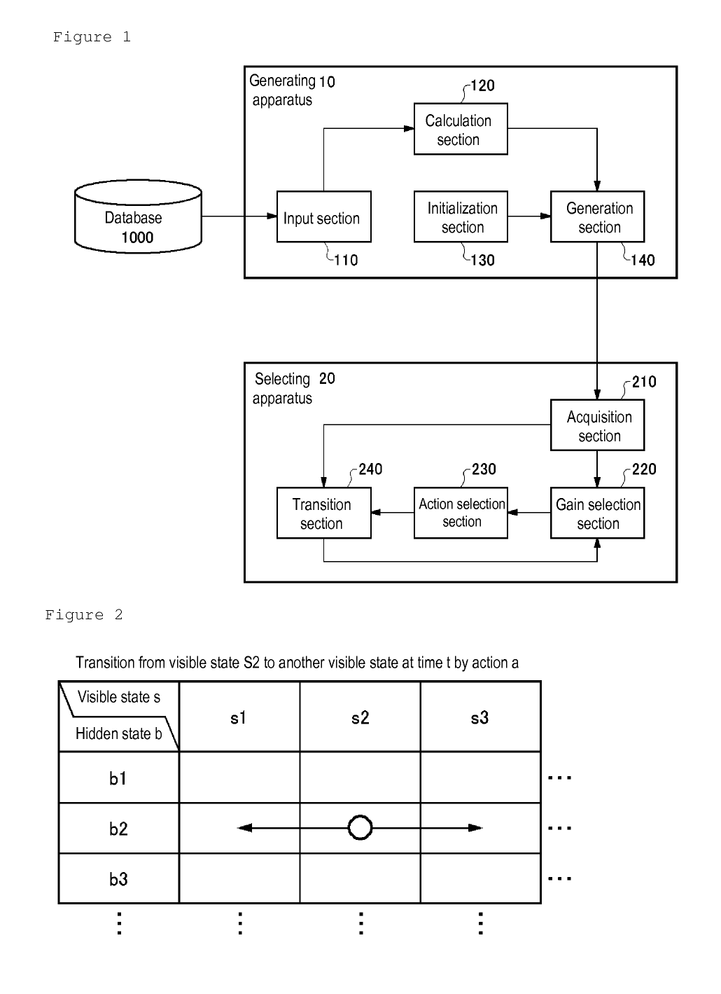

FIG. 1 illustrates an information processing system according to the present embodiment. In the information processing system according to the present embodiment, a set of gain vectors is generated with which a transition model having observable visible states and unobservable hidden states and expressing a transition from a present visible state to a subsequent visible state according to an action and/or a hidden state is formulated and an optimum action is selected on the basis of the set of gain vectors.

For example, whether consumers are in a state after viewing a television commercial of a particular commodity (e.g., a home electric appliance) and whether the consumers are in a state of being interested in the particular commodity are unobservable hidden states, and whether consumers are in a state of having viewed a Web advertisement of a particular commodity is a visible state observable through cookies.

In the information processing system according to the present embodiment, such a transition model is formulated and an action (e.g., a television commercial, direct mail, E-mail, or the like) for optimizing an expected gain (e.g., the sales) obtained from consumers is selected. The information processing system according to the present embodiment has a generating apparatus 10 that generates a set of gain vectors and a selecting apparatus 20 that selects a suitable action according to the set of gain vectors.

The generating apparatus 10 generates, for each of visible states, a set of gain vectors which include, with respect to each of hidden components, a component of a cumulative expected gain determined by adding up expected gains at points in time from a reference point in time to a future point in time on the basis of data for learning, and which can be used for calculation of a cumulative expected gain. The generating apparatus 10 is realized, by example, by executing a piece of software on a computer. The generating apparatus 10 is provided with an input section 110, a calculation section 120, an initialization section 130 and a generation section 140.

The input section 110 is provided with learning data for generating a set of gain vectors from a storage device such as an external database 1000 or an internal section of the generating apparatus 10. The input section 110 provides the learning data to the calculation section 120. The learning data may be, for example, a purchase history and an action history or the like about consumers.

The calculation section 120 calculates, from learning data, for each of visible states, a state transition probability representing a probability of transition from the visible state, and an expected gain which is a gain expected in the visible state according to an action. The calculation section 120 supplies the state transition probability and the expected gain to the generation section 140.

Before a set of gain vectors for one of visible states, which are used in a selecting function, is calculated for the entire time period for a transition model, the initialization section 130 initializes the set of gain vectors at a predetermined future point (e.g., the last point in time in the time period). For example, the initialization section 130 initializes the set of gain vectors for each visible state at a certain future point in time by setting the set of gain vectors as a set of zero vectors. The initialization section 130 provides the initialized set of gain vectors to the generation section 140.

The generation section 140 recursively generates, by retroacting from a future point in time, on the basis of a state transition probability and an expected gain, a set of gain vectors which has at least one gain vector to be used for calculation of a cumulative expected gain at and after a reference point in time and from which the gain vector which gives the maximum of the cumulative expected gain is to be selected. The generation section 140 may generate from the generated set of gain vectors a selecting function for selecting the gain vector which maximizes the cumulative expected gain at the reference point in time. A method for generating a set of gain vectors and other items with the generation section 140 will be described later in detail.

The generation section 140 also generates action association information including associations between actions and gain vectors at the time of generation of a set of gain vectors. The generation section 140 may supply the generated set of gain vectors, the state transition probability and action association information to the selecting apparatus 20. The generation section 140 may supply the selecting function in place of the set of gain vectors to the selecting apparatus 20.

The selecting apparatus 20 selects an optimum action on the basis of a set of gain vectors in a transition model having observable visible states and unobservable hidden states and expressing a transition from a present visible state to a subsequent visible state according to an action and/or a hidden state. For example, the selecting apparatus selects as an optimum action an action to optimize the gain. The selecting apparatus 20 is realized, for example, by executing a piece of software on a computer. The selecting apparatus 20 has an acquisition section 210, a gain selection section 220, an action selection section 230 and a transition section 240.

The acquisition section 210 obtains a set of gain vectors to be used for calculation of a cumulative expected gain after a reference point in time. For example, the acquisition section 210 may obtain a set of gain vectors generated by the generating apparatus 10.

The acquisition section 210 may also obtain a state transition probability and action association information from the generating apparatus 10. The acquisition section 210 supplies the obtained set of gain vectors and action association information to the gain selection section 220. The acquisition section 210 also supplies the state transition probability to the transition section 240.

The gain selection section 220 selects, on the basis of a set of gain vectors, from gain vectors according to the present visible state, the gain vector which maximizes a cumulative expected gain with respect to a probability distribution over hidden states at the present point in time. For example, the gain selection section 220 generates a selecting function for selecting one gain vector from a set of gain vectors, and selects, on the basis of this selecting function, the gain vector which maximizes a cumulative expected gain. The gain selection section 220 supplies the selected gain vector and action association information to the action selection section 230.

The action selection section 230 selects, on the basis of action association information, an action corresponding to the gain vector selected by the gain selection section 220, which is an optimum action. The action selection section 230 selects as an optimum action an action to maximize the cumulative expected gain, for example. The action selection section 230 supplies the selected action to the transition section 240.

The transition section 240 causes a probabilistic transition of the visible state on the basis of the state transition probability corresponding to the action selected by the action selection section 230 and the present probability distribution over the hidden states. The transition section 240 also updates the probability distribution over the hidden states according to the selected action. The transition section 240 supplies the updated visible state and probability distribution over the hidden states to the gain selection section 220. The gain selection section 220 is again made to select from the gain vectors on the basis of the visible state and the probability distribution over the hidden states.

Thus, in the information processing system according to the present embodiment, a recursive method is applied to a transition model expressing transition of an observable visible state, thereby enabling the generating apparatus 10 to generate a set of gain vectors at a high speed. Also, the selecting apparatus 20 can select an optimum action on the basis of a set of gain vectors generated by the generating apparatus 10.

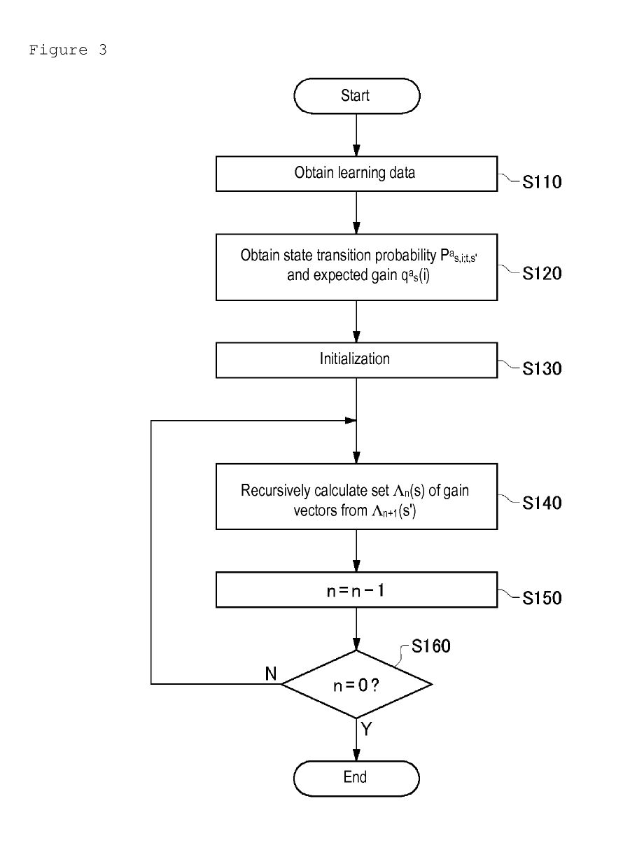

FIG. 2 illustrates an example of a visible state, s and a hidden state b in a transition model according to the present embodiment. As illustrated, the information processing system according to the present embodiment has observable visible states s1, s2, s3 . . . and unobservable hidden states b1, b2, b3 . . . . In the present embodiment, visible states and hidden states are given independently of each other, as illustrated.

That is, in the present embodiment, some visible state (e.g., visible state s2) and some hidden state (e.g., hidden state b2) are given simultaneously. For example, in a case where an application which outputs a marketing policy to maximize a cumulative expected gain obtained by business transactions with customers on a Web-based selling site is applied to the information processing system according to the present embodiment, a marketing policy taken on customers and a reaction from the customers may be a visible state externally observable, and a hidden state may be a state not directly observable from the outside, e.g., customer's tastes.

In the information processing system according to the present embodiment, a transition model is handled in which transition of a visible state can be made in a time period (e.g., visible state s2→s1 or s3), while no transition is made between hidden states (for example, no transition from hidden state b2 is made).

Since any hidden state is not observable, one hidden state b2 is not identifiable as illustrated in practice; only a probability distribution b {b(i)|i=1, . . . |B|} representing the probability of being in each hidden state i is calculated. In some case, the probability as to identification of the present hidden state is indirectly ascertained as a result of a state transition of a visible state, and a transition of the probability distribution b can occur. For example, if the probability of visible state transition s2→s1 in the hidden state b2 is extremely high, the probability of the hidden state b2 being produced in the probability distribution b at point t+1 in time is increased in correspondence with observation of the visible state s2→s1 from point t in time to point t+1 in time.

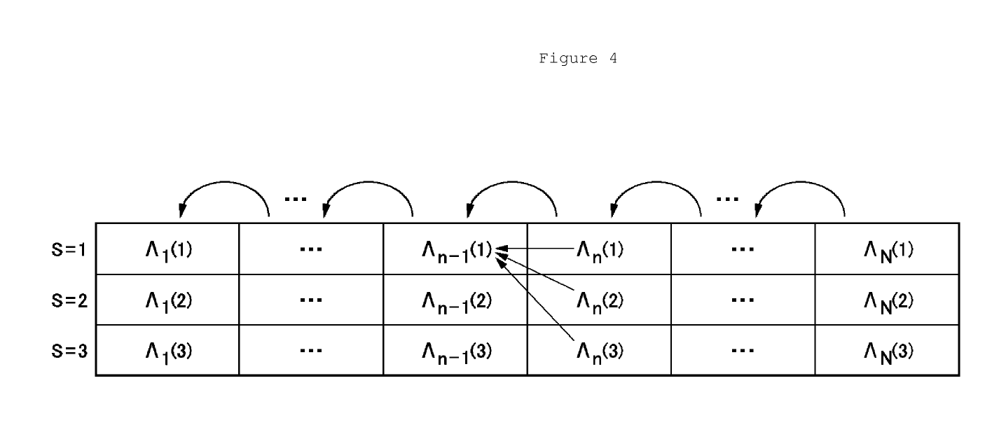

FIG. 3 illustrates a processing flow in the generating apparatus 10 according to the present embodiment. In the present embodiment, the generating apparatus 10 generates a set of gain vectors by executing processing from S110 to S160.

First, in S110, the input section 110 obtains learning data from the database 1000 provided outside or inside the generating apparatus 10. For example, the input section 110 may be supplied with learning data which is data including visible states, contents of actions and observation results defined in time series.

The input section 110 may alternatively obtain, as learning data, data including no visible states defined. For example, the input section 110 may first obtain, as learning data, policies, such as advertisements provided to a plurality of consumers, and a history of consumer's actions such as purchases of commodities. The input section 110 may subsequently define the visible states by generating a time series of state vectors from the action history or the like and by discretizing the state vectors.

The input section 110 may also obtain, as learning data, data usable for inference of a hidden state. For example, the input section 110 may obtain, as learning data, results of a questionnaire survey in which consumer's tastes for example are described. The input section 110 may define a hidden state by generating feature vectors from questionnaire survey results or the like and by discretizing the feature vectors. The input section 110 provides the learning data to the calculation section 120.

In S120, the calculation section 120 calculates a state transition probability and an expected gain from the learning data. For example, the calculation section 120 defines from the learning data one or more visible states s (s ε S) among which a transition can be made and one or more hidden states i (i ε B) among which no transition is made, and calculates a state transition probability P^{a}_{s,i};_{t,z} of transition from the visible state, s to a visible state t and observation of z when an action a is executed in the visible state, s and a hidden state i, and an expected gain q^{a}ₛ(i) when the action a is executed in the visible state, s and the hidden state i. The calculation section 120 may calculate the state transition probability P^{a}_{s,i};_{t,z} and the expected gain q^{a}ₛ(i) by a reinforcement learning method such as Q-learning. The calculation section 120 supplies the calculated state transition probability P^{a}_{s,i};_{t,z} and expected gain q^{a}ₛ(i) to the generation section 140.

Subsequently, in S130, the initialization section 130 initializes a set Λ_{N}(s) of gain vectors α_{s,N} with respect to the visible state, s at a future point N in time (N: an integer equal to or larger than 2) in a transition model. For example, the initialization section 130 initializes the set Λ_{N}(s) of α_{s,N} by setting the set Λ_{N}(s) as a set {(0, . . . , 0)} consisting of a vector |B| zeros, where |B| denotes the number of hidden states. The initialization section 130 initializes n to n=N−1. The initialization section 130 provides the initialized set Λ_{N}(s) to the generation section 140.

Subsequently, in S140, the generation section 140 generates a set Λₙ(s) of gain vectors α_{s,n} from a set Λₙ₊₁(s) with respect to n as shown by 1≦n≦N−1. The set Λₙ(s) of gain vectors α_{s,n} generated by the generation section 140 includes at least one gain vector α_{s,n} having a component α_{s,n}(i) of a cumulative expected gain with respect to each hidden state i.

FIG. 4 illustrates an example of a method for generating the set Λₙ(s) with the generation section 140 in the present embodiment. The generation section 140 recursively generates the set Λₙ(s) of gain vectors α_{s,n} with respect to visible state, s (s ε S, S: the set of visible states) at point n in time on the basis of a set Λₙ₊₁(s′) of gain vectors α_{s′,n+1} with respect to each of visible states s′ (s′ ε S) at subsequent point n+1 in time.

For example, if the visible state s1 includes visible states s1, s2 and s3 as illustrated, the generation section 140 may generate a set Λₙ(1) at point n in time from sets Λₙ₊₁(1), Λₙ₊₁(2), and Λₙ₊₁(3) of gain vectors at point n+1 in time. The generation section 140 generates the set of gain vectors on the basis of the state transition probability of transition from one visible state, s, to the visible state, s′, at point n+1 in time according to the action and the expected gain obtained in the visible state, s′, according to the action. A concrete generation method for this will be described later.

The generation section 140 may generate, on the basis of the set Λₙ(s) of gain vectors α_{s,n} generated, according to the visible state, s and the probability distribution b over the hidden states, a selecting function Kmaxₙ(s, b) for selecting the gain vector which maximizes the cumulative expected gain at and after the reference point n in time. For example, the generation section 140 generates a selecting function for selecting the gain vector which maximizes the cumulative expected gain based on the sum of values each determined by multiplying the probability of one hidden state being i in probability distribution b by one of the components of the gain vectors.

As an example, the generation section 140 generates a selecting function Kmaxₙ(s, b) shown by expression (1), where b(i) represents the probability of the hidden state being i, and α_{s,n}^{k}(i) represents the component corresponding to the hidden state i of the kth gain vector α_{s,n}^{k} corresponding to the visible state, s at point n in time. The generation section 140 also generates action association information including associations between actions and the gain vectors in the process of generating the selecting function Kmaxₙ(s, b).

$${K max}_{n} ( s , b ) = arg {max}_{k} [ {\sum }_{i in B } b ( i ) {α}_{s , n}^{k} ( i ) ] for n < N$$

Subsequently, in S150, the generation section 140 subtracts 1 from n and advances the process to S160.

In S160, the generation section 140 determines whether or not n=0. If n=0, the generation section 140 ends the process. If n is not zero, the generation section 140 returns the process to S140. The generation section 140 thereby generates recursively the set Λₙ(s) of gain vectors and/or the selecting function Kmaxₙ(s, b) while n changes from N to zero.

Thus, the generating apparatus 10 first calculates from the learning data the state transition probability P^{a}_{s,i};_{t,z} and the expected gain q^{a}ₛ(i) and recursively calculates Λₙ(s) from the set Λₙ₊₁(s) of gain vectors on the basis of the calculated probability and gain. Since the generating apparatus 10 generates the set Λₙ(s) of gain vectors in the model in which no transition from the hidden state b is made, the speed of processing can be increased.

The hidden state from which no transition is made can be considered as a characteristic not easily changeable in an environment. For example, the generating apparatus 10 can generate a set of gain vectors for selecting an optimum policy after incorporating a consumer's preference not easily observable in ordinary cases and not changed during a long time period (e.g., a preference for a meal or a hobby) in the model.

The generating apparatus 10 can be used in a robot having a plurality of sensors and capable of operating autonomously. For example, the generating apparatus 10 can adopt as a state from which no transition is made a state where part of a plurality of sensors are malfunctioning. For example, the generating apparatus 10 may set in a hidden state a matter to be detected with a malfunctioning sensor, thereby enabling the provision of a set of gain vectors for selecting an optimum policy upon considering the malfunctioning sensor.

The generating apparatus 10 can also be applied to a conversational speech generation device used in a speech recognition apparatus. For example, the generating apparatus 10 can treat as a hidden state the contents of a conversational speech not clearly caught. The generating apparatus 10 can thereby provide a set of gain vectors for selecting an optimum policy (e.g., a reply to a person in conversation) even in a situation where human conversational speech is not clearly caught.

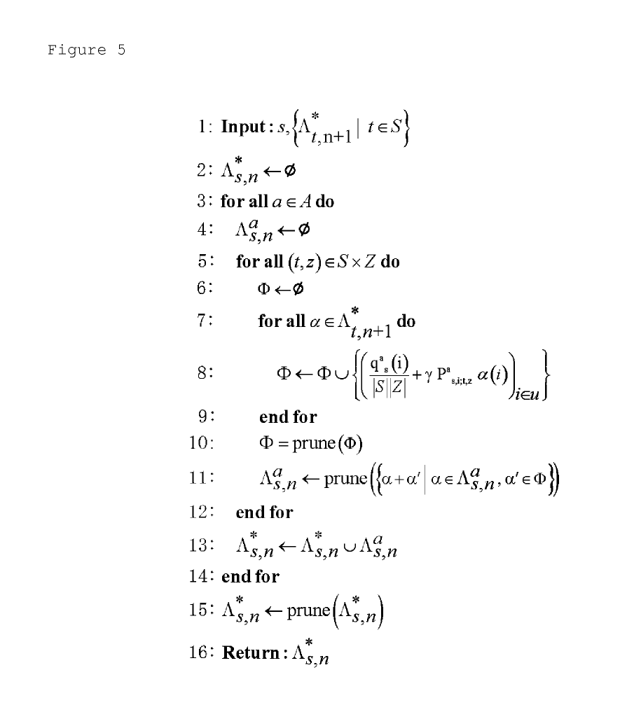

FIG. 5 illustrates an example of a concrete algorithm for the processing flow in FIG. 3. An algorithm for processing in S140 will be described with reference to FIG. 5 by way of example.

First, as shown in the first line, the generation section 140 obtains a set Λ_{t,n+1} of gain vectors in the state t (t ε S) at point n+1 in time. In some case, a set Λ_{x(y)} is expressed as Λ_{x,y} or Λ_{(y,x)}.

Subsequently, as shown in the second line, the generation section 140 initializes a set Λ*_{s,n} of gain vectors corresponding to all actions at point n in time by setting this set as an empty set.

Subsequently, as shown in the third line, the generation section 140 executes for each action a (a ε A, A: a set of actions) a first loop processing defined in the third to fourteenth lines.

As shown in the fourth line, the generation section 140 initializes the set Λ^{a}_{s,n} of gain vectors associated with the action a in the first loop processing by setting this set as an empty set.

Subsequently, as shown in the fifth line, the generation section 140 executes a second loop processing defined in the fifth to twelfth lines for each combination of the visible state t (t ε S) and observation z (z ε Z, Z: a set of observations) in the first loop processing.

As shown in the sixth line, the generation section 140 initializes a vector set Φ in the second loop processing by setting this set as an empty set.

Subsequently, as shown in the seventh line, the generation section 140 executes a third loop processing defined in the seventh to ninth lines on each gain vector α (α ε Λ*_{s,n+1}) in the second loop processing.

As shown in the eighth line, the generation section 140 updates the vector set Φ in the third loop processing. More specifically, the generation section 140 forms the union of the existing vector set Φ and a new vector generated on the basis of the gain vector α at point n+1 in time.

The generation section 140 generates a new vector at time n having as a component corresponding to the hidden state i the sum of the quotient of the expected gain q^{a}ₛ(i) divided by the number |S| of visible states s and the number |Z| of observations z and the product of the rate γ of reduction (0<γ<1) with respect to the future gain, the state transition probability P^{a}_{s,i;t,z} and the component α(i) in the hidden state i of the gain vector α (i.e., the component of the cumulative expected gain corresponding to the hidden state i).

The generation section 140 may generate a new vector by setting γ=1 so that the future gain is not reduced.

Subsequently, as shown in the tenth line, the generation section 140 may prune the updated vector set Φ by a prune function after the third loop processing in the second loop processing. Of the vectors in the input vector set, those other than the vectors that achieve the maximum values of the inner product with some probability distributions b over hidden states are removed by the prune function.

Subsequently, as shown in the eleventh line, the generation section 140 generates the set Λ^{a}_{s,n} of gain vectors at point n in time in the second loop processing. More specifically, the generation section 140 generates a sum vector by adding the vector α and vector α′ with respect to all combinations of vectors α contained in the present set Λ^{a}_{s,n} of gain vectors and vectors α′ contained in the vector set Φ, and prunes the sum vector by the prune function, thereby generating the set Λ^{a}_{s,n} of new gain vectors. The generation section 140 generates the set Λ^{a}_{s,n} of gain vectors corresponding to the action a in this way and can therefore generate action association information as information on the association between the action and the gain vector.

Subsequently, as shown in the thirteenth line, the generation section 140 updates the set Λ*_{s,n} of gain vectors after the second loop processing in the first loop processing. More specifically, the generation section 140 updates the set Λ*_{s,n} by taking the union of the set Λ*_{s,n} and the set Λ^{a}_{s,n}.

Subsequently, as shown in the fifteenth line, the generation section 140 updates the set Λ*_{s,n} after the first loop processing. More specifically, the generation section 140 updates the set Λ*_{s,n} by inputting the set Λ*_{s,n} to the prune function.

Subsequently, as shown in the sixteenth line, the generation section 140 outputs the set Λ*_{s,n} as a set of gain vectors in the state, s at point n in time.

Thus, the generating apparatus 10 generates the gain vector Λ_{s,n} corresponding to the visible state, s at point n in time on the basis of the expected gain q^{a}ₛ(i) in the visible state, s at point n+1 in time with respect to each hidden state i, Λ_{s,n+1} in the visible state, s at point n+1 in time and the discount rate γ.

The generating apparatus 10 also generates the set Λ_{s,n} by removing, from the set of gain vectors α_{s,n} contained in the set Λ_{s,n}, at each point n in time and each visible state, s, by the prune function, the gain vectors other than those achieving the maximum values of the inner product with some probability distributions b over hidden states.

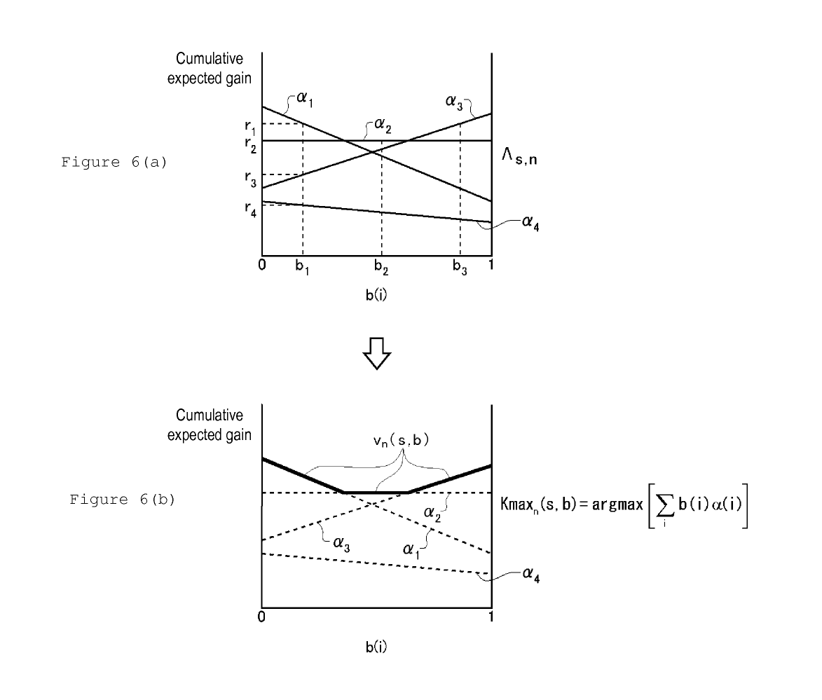

FIG. 6 illustrates the relationship between the set Λ_{s,n} of gain vectors and the cumulative expected gain. FIG. 6(a) illustrates the relationship between the set Λ_{s,n} and the cumulative expected gain. The set Λ_{s,n} of gain vectors are assumed to include gain vectors α₁, α₂, α₃, and α₄. Each gain vector can be used for calculation of the value of the cumulative expected gain according to the probability distribution b over the hidden states. For ease of description with reference to FIG. 6, it is assumed that each gain vector returns the value of the cumulative expected gain not according to the probability distribution b but according only to the value of the probability b(i) of being in one hidden state i.

For example, if the probability b(i) of being in the hidden state i is b₁, the gain vector α₁ returns a cumulative expected gain γ₁ according to the value of b₁; the gain vector α₂, a cumulative expected gain γ₂ according to the value of b₁; the gain vector α₃, a cumulative expected gain γ₃ according to the value of b₁; and the gain vector α₄, a cumulative expected gain γ₄ according to the value of b₁.

As illustrated, the cumulative expected gain γ₁ is the maximum among the cumulative expected gains γ₁ to γ₄. Therefore the gain vector α₁ corresponding to the cumulative expected gain γ₁ can be selected from the set of gain vectors α₁ to α₄ according to the probability b₁. For example, the selecting function outputs a number 1 corresponding to the gain vector α₁ in response to input of the probability b₁. Similarly, the selecting function outputs the gain vector α₂ taking the maximum of the cumulative expected gain in response to input of the probability b₂, and outputs the gain vector α₃ taking the maximum of the cumulative expected gain in response to input of the probability b₃.

Since the action is associated with each gain vector, the optimum action can be selected by inputting the probability distribution b over the hidden states to the selecting function. For example, when the selecting function outputs the number 1 corresponding to the gain vector α₁, the action corresponding to the number 1 can be selected as the optimum action.

FIG. 6(b) illustrates a gain function which is obtained by connecting portions of the gain vectors having the maximums, and which returns the maximum of the cumulative expected gain. As illustrated, when only the segments with the maximums of the cumulative expected gain in the lines for the plurality of gain vectors α₁ to α₄ are connected, a gain function vₙ(s, b) in the form of a piecewise linear downward-convex function indicated by a thick line is obtained. The gain function vₙ(s, b) is a function expressed by vₙ(s, b)=max[Σᵢ b(i)α(i)] and dependent on the visible state, s and the probability distribution b over the hidden states.

When generating the set Λ_{s,n} the generation section 140 removes, by the prune function, the gain vectors (e.g., the gain vector α₄) having no segment in which the cumulative expected gain is maximized. The generation section 140 can thus improve the calculation efficiency by eliminating from the gain vectors to be used in the selecting function useless ones not contributing to selection from the actions.

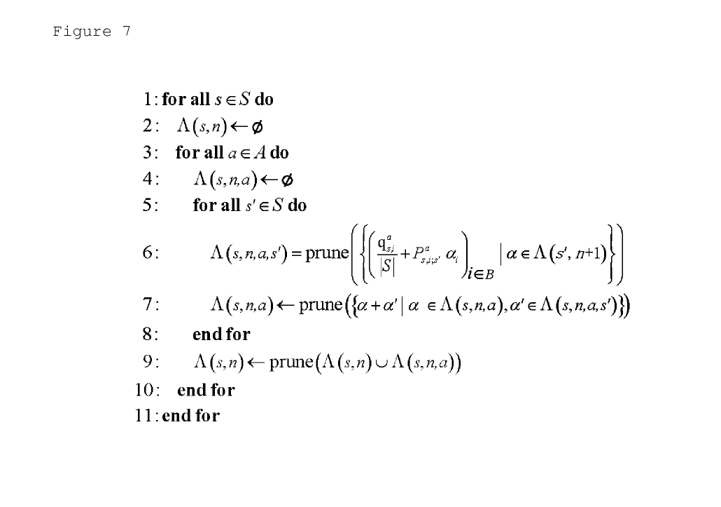

FIG. 7 illustrates another example of a concrete algorithm for the processing flow in FIG. 3. An algorithm for processing in S140 will be described with reference to FIG. 7 and to the example in FIG. 5. By the algorithm in this example, calculation of the set Λ_{n, t} is performed without considering observation z (z ε Z) unlike that shown in FIG. 5.

First, as shown in the first line, the generation section 140 executes for each visible state, s (s ε S) a first loop processing defined in the first to eleventh lines.

Subsequently, as shown in the second line, the generation section 140 initializes a set Λ_{(s,n)} of gain vectors corresponding to all actions in the first loop processing by setting this set as an empty set.

Subsequently, as shown in the third line, the generation section 140 executes for each action a (a ε A) a second loop processing defined in the third to tenth lines.

Subsequently, as shown in the fourth line, the generation section 140 initializes a set Λ_{(s,n,a)} of gain vectors associated with an action a in the second loop processing by setting this set as an empty set.

Subsequently, as shown in the fifth line, the generation section 140 executes a third loop processing defined in the fifth to eighth lines on each visible state, s′ (s′ ε S) in the second loop processing. The visible state, s′ represents the visible state at point n+1 in time.

As shown in the sixth line, the generation section 140 generates a set Λ_{(s,n,a,s′)} of gain vectors in the third loop processing. More specifically, the generation section 140 generates a new vector with respect to each gain vector α contained in the set Λ_{(s′,n+1)} at point n+1 in time. A state transition probability P^{a}_{s,i;s′} represents the probability of transition from the visible state, s to the visible state, s′ when the action a is executed in the visible state, s and the hidden state i.

For example, the generation section 140 generates a new vector from the gain vector α by setting, with respect to each hidden state i, as a component of the new vector corresponding to the hidden state i, the sum of the quotient of the expected gain q^{a}_{s,i} divided by the number |S| of the visible state, s and the product of the state transition probability P^{a}_{s,i;s′} and the component α(i) in the hidden state i of the gain vector α. The generation section 140 generates the set Λ_{(s,n,a,s′)} by inputting the generated new vector to a prune function.

Subsequently, as shown in the seventh line, the generation section 140 generates the set Λ_{(s,n,a)} in the third loop processing. More specifically, the generation section 140 generates a sum vector by adding the vector α and vector α′ with respect to all combinations of vectors α contained in the set Λ_{(s,n,a)} and vectors α′ contained in the set Λ_{(s,n,a,s′)}, and inputs the sum vector to the prune function, thereby generating the new set Λ_{(s,n,a)}. The generation section 140 can thereby associate actions a and the gain vectors contained in the set Λ_{(s,n,a)} with each other.

Subsequently, as shown in the ninth line, the generation section 140 updates the set Λ_{(s,n)} after the third loop processing in the second loop processing. More specifically, the generation section 140 updates the set Λ_{(s,n)} by adding the set Λ_{(s,n)} and the set Λ_{(s,n,a)} together.

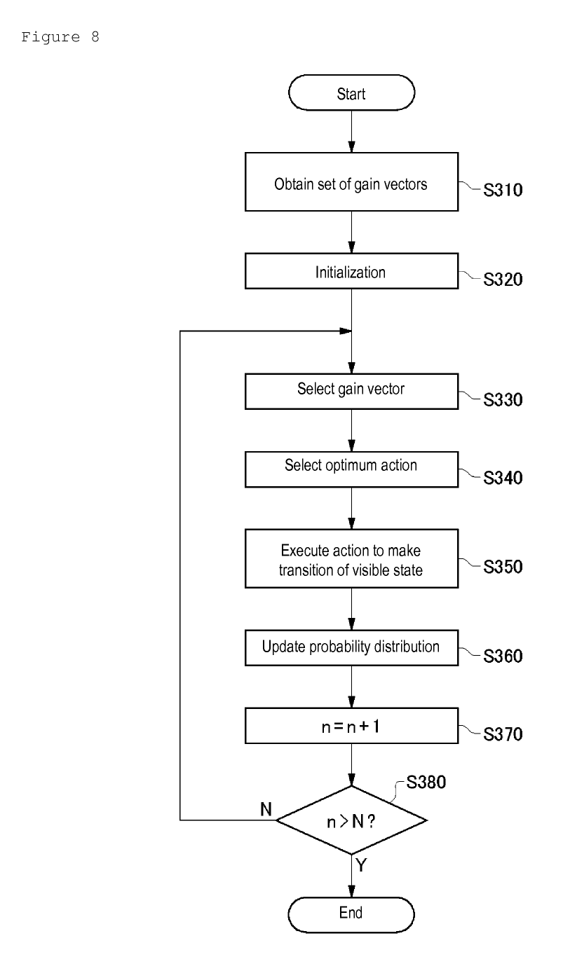

FIG. 8 illustrates a processing flow in the selecting apparatus 20 according to the present embodiment. In the present embodiment, the selecting apparatus 20 selects an optimum action by executing processing from S310 to S380.

First, in S310, the acquisition section 210 obtains the set Λ_{s,n} of gain vectors to be for calculation of cumulative expected gains at and after a reference point in time.

The acquisition section 210 may also obtain from the generating apparatus 10 action association information including the state transition probability P^{a}_{s,i},_{s′} of transition from one visible state, s to another visible state, s′ in the state set S when one action a is provided in the hidden state i, and associations between the action a and the gain vector α_{s,n}^{a}.

The acquisition section 210 supplies the obtained set Λ_{s,n} of gain vectors and action association information to the gain selection section 220. The acquisition section 210 also supplies the state transition probability P^{a}_{s,i,s′} to the transition section 240.

Subsequently, in S320, the acquisition section 210 executes initialization of the environment to be simulated. For example, the acquisition section 210 sets initial conditions for visible states and hidden states.

For example, the acquisition section 210 may set as initial conditions (s₀, b₀) for simulation, a visible state, s₀ at a future point in time and a probability distribution b₀ over hidden states in learning data obtained from the database 1000 by the generating apparatus 10. Also, for example, the acquisition section 210 may obtain directly from the database 1000 or the like initial conditions about visible states and hidden states in the environment.

Also, the acquisition section 210 initializes the point n in time by setting the point n in time to 1. The acquisition section 210 sets a future point N in time. For example, the acquisition section 210 sets a predetermined number as the point N in time. The acquisition section 210 supplies the results of initialization to the gain selection section 220.

Subsequently, in S330, the gain selection section 220 selects from the gain vectors α according to the present visible state, s the gain vector α which maximizes the cumulative expected gain with respect to the probability distribution b over the hidden states at the present point in time.

For example, the gain selection section 220 generates the selecting function Kmaxₙ(s, b) expressed by expression (1) from the set Λ_{s,n} of gain vectors and prescribed on the basis of the probability b(i) of the hidden state being i and α_{s,n}^{k}(i) corresponding to the hidden state i of the kth gain vector α_{s,n}^{k} corresponding to the visible state, s at point n in time.

$${K max}_{n} ( s , b ) = arg {max}_{k} [ {\sum }_{i in B } b ( i ) {α}_{s , n}^{k} ( i ) ] for n < N$$

Subsequently, the gain selection section 220 inputs the present visible state, s and the probability distribution b over the hidden states to the selecting function Kmaxₙ(s, b) to select the gain vector α^{k}_{s,n} determined in correspondence with the probability distribution b over the hidden states. The gain selection section 220 may select the gain vector α^{k}_{s,n} by the selecting function Kmaxₙ(s, b) obtained through the acquisition section 210 in place of the set Λ_{s,n} of gain vectors. The gain selection section 220 supplies the selected gain vector α^{k}_{s,n} and action association information to the action selection section 230.

Subsequently, in S340, the action selection section 230 selects as an optimum action the action corresponding to the gain vector selected by the gain selection section 220. For example, the action selection section 230 selects, on the basis of the action association information, an action k associated with the gain vector α^{k}_{s,n} in advance as an optimum action k which gives the maximum cumulative expected gain when the action is executed at point n in time. The action selection section 230 supplies the selected action k to the transition section 240.

Subsequently, in S350, the transition section 240 causes a probabilistic transition from the visible state, s in response to the execution of the action k selected by the action selection section 230 on the basis of the state transition probability corresponding to the selected action and the preset probability distribution b over the hidden states.

That is, the transition section 240 causes a transition from the present visible state, s to one visible state t (t ε S) with a state transition probability P^{k}_{s,i;t,z}.

Subsequently, the transition section 240 updates the probability distribution b over the hidden states on the basis of a state transition probability P^{k}_{s,i,s′,z} corresponding to the selected action k and the present probability distribution b over the hidden states. For example, the transition section 240 updates the probability distribution b over hidden states by substituting the result of computation by expression (2) in the probability b(i) of the hidden state being i.

$$b ( i ) = \frac{b ( i ) {p}_{s , i ; {s}^{′} , z}^{a}}{{Σ}_{j ∈ B} b ( j ) {p}_{s , j ; {s}^{′} , z}^{a}}$$

In the case of a transition model without consideration of observation z, the transition section 240 updates the probability distribution b over the hidden states on the basis of a state transition probability P^{k}_{s,i,s′} corresponding to the selected action k and the present probability distribution b over the hidden states. For example, the transition section 240 updates the probability distribution b over the hidden states by substituting the result of computation by expression (3) in the probability b(i) of the hidden state being i.

$$b ( i ) = \frac{b ( i ) {p}_{s , i ; {s}^{′}}^{a}}{{Σ}_{j ∈ B} b ( j ) {p}_{s , j , {s}^{′}}^{a}}$$

Subsequently, in S370, the transition section 240 adds 1 to n. The transition section 240 then advances the process to S380.

Subsequently, in S380, the transition section 240 determines whether n exceeds N. If n>N, the transition section 240 ends the process. If n is not larger than N, the transition section 240 returns the process to S330.

Thus, the selecting apparatus 20 can select and output an optimum policy according to the visible state, s and the probability distribution b over the hidden states by using the set Λ_{s,n} of gain vectors generated by the generating apparatus 10.

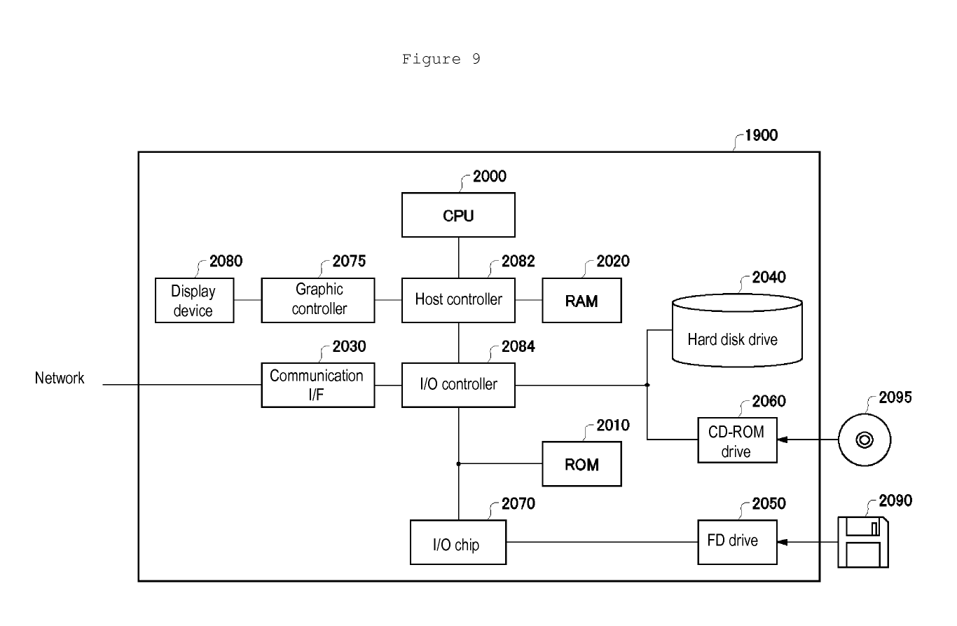

FIG. 9 illustrates an example of a hardware configuration of a computer 1900 functioning as the generating apparatus 10 and/or the selecting apparatus 20. The computer 1900 according to the present embodiment is provided with CPU peripheral sections: a CPU 2000, a RAM 2020, a graphic controller 2075 and a display device 208, connected to each other by a host controller 2082, input/output sections: a communication interface 2030, a hard disk drive 2040 and a CD-ROM drive 2060, connected to the host controller 2082 by an input/output controller 2084, and legacy input/output sections: a ROM 2010, a flexible disk drive 2050 and an input/output chip 2070, connected to the input/output controller 2084.

The host controller 2082 connects the RAM 2020 and the CPU 2000 and the graphic controller 2075, which access the RAM 2020 at a high transfer rate. The CPU 2000 operates on the basis of a program stored in the ROM 2010 and the RAM 2020 to control each section. The graphic controller 2075 obtains image data generated on a frame buffer provided in the RAM 2020 by the CPU 2000 for example, and displays the image data on the display device 2080. The graphic controller 2075 may alternatively incorporate the frame buffer for storing image data generated by the CPU 2000 for example.

The input/output controller 2084 connects the host controller 2082, the communication interface 2030, which is an input/output device of a comparatively high speed, the hard disk drive 2040 and the CD-ROM drive 2060. The communication interface 2030 communicates with another device over a wired or wireless network. The communication interface also functions as a piece of hardware for performing communication. The hard disk drive 2040 stores programs and data used by the CPU 2000 in the computer 1900. The CD-ROM drive 2060 reads out a program or data from a CR-ROM 2095 and provides the program or data to the hard disk drive 2040 through the RAM 2020.

The ROM 2010 and the flexible disk drive 2050 and the input/output chip 2070, which are input/output devices of a comparatively low speed, are connected to the input/output controller 2084. A boot program executed by the computer 1900 at the time of startup and/or a program or the like dependent on the hardware of the computer 1900 are stored in the ROM 2010. The flexible disk drive 2050 reads out a program or data from a flexible disk 2090 and provides the program or data to the hard disk drive 2040 through the RAM 2020. The input/output chip 2070 connects the flexible disk drive 2050 to the input/output controller 2084 and also connects various input/output devices to the input/output controller 2084, for example, through a parallel port, a serial port, a keyboard port, a mouse port, and the like.

A program to be provided to the hard disk drive 2040 through the RAM 2020 is provided for a user by being stored on a recording medium such as the flexible disk 2090, the CR-ROM 2095 or an IC card. The program is read out from the recording medium, installed in the hard disk drive 2040 in the computer 1900 through the RAM 2020 and executed in the CPU 2000.

A program installed in the computer 1900 to cause the computer 1900 to function as the generating apparatus 10 and the selecting apparatus 20 includes an input module, a calculation module, an initialization module, a generation module, an acquisition module, a gain selection module, an action selection module and a transition module. The program or the modules may act on the CPU 2000 or the like to cause the computer 1900 to function as each of the input section 110, the calculation section 120, the initialization section 130, the generation section 140, the acquisition section 210, the gain selection section 220, the action selection section 230, and the transition section 240.

Information processing described on the program is read to the computer 1900 to cause concrete means in which pieces of software and the above-described various hardware resources cooperate with each other to function as the input section 110, the calculation section 120, the initialization section 130, the generation section 140, the acquisition section 210, the gain selection section 220, the action selection section 230, and the transition section 240. By these concrete means, calculation or processing of information according to purposes of use of the computer 1900 in the present embodiment is realized, thus constructing the specific generating apparatus 10 and selecting apparatus 20 according to the use purposes.

For example, when communication is performed between the computer 1900 and an external device or the like, the CPU 2000 executes a communication program loaded on the RAM 2020 to direct the communication interface 2030 to perform communication processing on the basis of details of processing described in the communication program. The communication interface 2030 under the control of the CPU 2000 reads out transmission data stored on a transmission buffer area or the like provided on a storage device, e.g., the RAM 2020, the hard disk drive 2040, the flexible disk 2090 or the CD-ROM 2095, and transmits the read data over a network or writes reception data received from the network to a reception buffer area or the like provided on the storage device. The communication interface 2030 may transfer transmission or reception data between itself and the storage device by DMA (direct memory access). The CPU 2000 may alternatively read out data from the storage device or the communication interface 2030 as a transfer source and transfer transmission or reception data by writing the data to the communication interface 2030 or the storage device as a transfer destination.

Also, the CPU 2000 reads the whole or a necessary portion of a file stored on an external storage device, e.g., the hard disk drive 2040, the CD-ROM drive 2060 (CD-ROM 2095) or the flexible disk drive 2050 (flexible disk 2090) or data in a database or the like to the RAM 2020 by DMA transfer or the like, and performs various kinds of processing on the data on the RAM 2020. The CPU 2000 writes the processed data back to the external storage device by DMA transfer or the like. The RAM 2020 can be considered to temporarily hold the contents of the external storage device in such a process. In the present embodiment, therefore, the RAM 2020, the external storage device and the like are generally referred to as a memory, a storage section or a storage device for example.

Various sorts of information such as various programs, data, tables and databases in the present embodiment are stored in such a storage device and can be subjected to information processing. The CPU 2000 can also hold part of the RAM 2020 on a cache memory and perform read/write on the cache memory. Also in such a form, the cache memory performs part of the functions of the RAM 2020. In the present embodiment, therefore, the cache memory is assumed to be included in the RAM 2020, the memory and/or the storage device except when discriminably categorized.

The CPU 2000 also performs on data read out from the RAM 2020 any of various kinds of processing including various calculations described in the description of the present embodiment, processing of information determination of conditions, and information search and replacement, designated by sequences of instructions in programs, and writes the processed data to the RAM 2020. For example, in the case of making a determination as to a condition, the CPU 2000 determines whether or not one of the various variables described in the description of the present embodiment satisfies a condition, for example, as to whether it is larger or smaller than, equal to or larger than, equal to or smaller than, or equal to another variable or a constant. If the condition is met (or not met), the process branches off to a different sequence of instructions or a subroutine is called up.

The CPU 2000 can also search information stored in a file in the store device, a database or the like. For example, in a case where a plurality of entries are stored in the storage device such that attribute values of a second attribute are respectively associated with attribute values of a first attribute, the CPU 2000 may search for the entry in which the attribute values of the first attribute coincide with a designated condition in the plurality of entries stored in the storage device, and read out the attribute values of the second attribute stored in the entry. The attribute values of the second attribute associated with the first attribute satisfying the predetermined condition can thereby be obtained.

The above-described programs or modules may be stored on an external storage medium. As this storage medium, an optical recording medium such as a DVD or a CD, a magneto-optical recording medium such as MO, a tape medium and a semiconductor memory such as an IC card can be used as well as the flexible disk 2090 and the CD-ROM 2095. A storage device such as a hard disk or a RAM provided in a server system connected to a special-purpose communication network or the Internet may be used as the recording medium to provide the programs to the computer 1900 through the network.

While the present invention has been described by using the embodiment, the technical scope of the present invention is not limited to that described in the above description of the embodiment. It is apparent for those skilled in the art that various changes and modifications can be made in the above-described embodiment. From the description in the appended claims, it is apparent that forms obtained by making such changes or modifications are also included in the technical scope of the present invention.

The order in which operations, procedures, steps, stages, etc., are executed in processing in the apparatuses, the system, the programs and the methods described in the appended claims, the specification and the drawings is not indicated particularly explicitly by “before”, “prior to” or the like. Also, it is to be noted that such process steps can be realized in a sequence freely selected except where an output from a preceding stage is used in a subsequent case. Even if descriptions are made by using “first”, “next”, etc., for convenience sake with respect to operation flows in the appended claims, the specification and the drawings, they are not intended to show the necessity to execute in the order specified thereby.

### REFERENCE SIGNS LIST

10 . . . Generating apparatus

110 . . . Input section

120 . . . Calculation section

130 . . . Initialization section

140 . . . Generation section

20 . . . Selecting apparatus

210 . . . Acquisition section

220 . . . Gain selection section

230 . . . Action selection section

240 . . . Transition section

1000 . . . Database

1900 . . . Computer

2000 . . . CPU

2010 . . . ROM

2020 . . . RAM

2030 . . . Communication interface

2040 . . . Hard disk drive

2050 . . . Flexible disk drive

2060 . . . CD-ROM drive

2070 . . . Input/output chip

2075 . . . Graphic controller

2080 . . . Display device

2082 . . . Host controller

2084 . . . Input/output controller

2090 . . . Flexible disk

2095 . . . CD-ROM

1. A computer implemented method for generating a set of gain vectors with respect to a transition model having observable visible states and unobservable hidden states and expressing a transition from a present visible state to a subsequent visible state according to an action, the set of gain vectors being generated for each visible state and used for calculation of a cumulative expected gain at and after a reference point in time, the method comprising:
recursively generating, with a processing device, by retroacting from a future point in time to the reference point in time, the set of gain vectors containing at least one gain vector including a component of a cumulative expected gain with respect to each hidden state, from which set of gain vectors the gain vector giving the maximum of the cumulative expected gain is to be selected.

2. The method of claim 1, further comprising initializing the set of gain vectors at a future point N in time, wherein N is an integer equal to or larger than 2.

3. The method of claim 1, further comprising recursively generating a set Λₙ(s) of gain vectors α_{s,n} with respect to a visible state, s (s ε S, where S is a set of visible states) at a point n in time on the basis of a set Λₙ₊₁(s′) of gain vectors α_{s′,n+1} with respect to one or more visible states s′ (s′ ε S) at a subsequent point n+1 in time.

4. The generation method of claim 3, further comprising generating a set Λₙ(s) of gain vectors α_{s,n} on the basis of a state transition probability of transition from one visible state, s at the point n in time to another visible state, s′ at the point n+1 in time according to an action and an expected gain obtained according to an action in the visible state, s′.

5. The method of claim 3, further comprising removing, from the set of gain vectors α_{s,n} contained in the set Λₙ(s) of gain vectors, at each point n in time and each visible state, s, the gain vectors other than the gain vector achieving the maximum value at least in a part of the space of the probability distributions over hidden states.

6. The method of claim 5, further comprising generating a set Λₙ(s) of gain vectors corresponding to the visible state, s at the point n in time further on the basis of a discount rate γ.

7. The method of claim 1, further comprising generating a selecting function for selecting, from the set of gain vectors, the gain vector maximizing the cumulative expected gain at and after the reference point in time according to a probability distribution over the hidden states.

8. The method of claim 7, further comprising generating a selecting function for selecting the gain vector maximizing the cumulative expected gain based on a total value obtained by multiplying a probability of taking each hidden state by each component of the gain vector.

9. The method of claim 8, further comprising generating a selecting function, Kmaxₙ(s, b) in accordance with the expression:
$${K max}_{n} ( s , b ) = arg {max}_{k} [ {\sum }_{i in B } b ( i ) {α}_{s , n}^{k} ( i ) ] for n < N$$
on the basis of a probability b(i) of the hidden state being i and a component α_{s,n}^{k}(i) of the kth gain vector α_{s,n}^{k} corresponding to the visible state, s at the point n in time, wherein N is an integer equal to or larger than 2 representing the reference point in time.

10. The method of claim 1, further comprising:
selecting an optimum action in a transition model having observable visible states and unobservable hidden states and expressing a transition from a present visible state to a subsequent visible state according to an action;
obtaining, with respect to each visible state, a set of gain vectors containing at least one gain vector including a component of a cumulative expected gain with respect to each hidden state, the set of gain vectors being for calculation of a cumulative expected gain at and after a reference point in time;
selecting, from the gain vectors according to the present visible state, the gain vector maximizing the cumulative expected gain with respect to a probability distribution over the hidden states at the present point in time; and
selecting an action corresponding to the selected gain vector as an optimum action.

11. The method of claim 10, further comprising obtaining a set of gain vectors generated by the recursive generating.

12. The method of claim 11, further comprising:
generating a selecting function, Kmaxₙ(s, b) in accordance with the expression
$${K max}_{n} ( s , b ) = arg {max}_{k} [ {\sum }_{i in B } b ( i ) {α}_{s , n}^{k} ( i ) ] for n < N$$
and based on a probability b(i) of the hidden state being i and a component α_{s,n}^{k}(i) corresponding to a hidden state i of the kth gain vector α_{s,n}^{k} corresponding to the visible state, s at the point n in time; and
selecting a gain vector α_{s,n}^{k}(i) determined in correspondence with the probability distribution b over the hidden state on the basis of the selecting function Kmaxₙ(s, b).

13. The method of claim 10, obtaining a state transition probability P^{a}_{s,i,s′} of transition from one visible state, s to another visible state, s′ in a state set S when one action a is input in a hidden state i, the method further comprising causing a transition from the visible state, s in response to execution of the action, a, on the basis of the state transition probability P^{a}_{s,i,s′} corresponding to the selected action a and the present probability distribution over the hidden states.

14. The method of claim 13, further comprising updating the probability distribution b over the hidden states on the basis of the state transition probability P^{a}_{s,i,s′} and the present probability distribution over the hidden states.

15. The method of claim 14, further comprising updating the probability distribution b over the hidden states by substituting, in the probability b(i) of the hidden state being i in response to the action selected, in accordance with the expression:
$$b ( i ) = \frac{b ( i ) {p}_{s , i ; {s}^{′}}^{a}}{{Σ}_{j ∈ B} b ( j ) {p}_{s , j , {s}^{′}}^{a}}$$
wherein P^{a}_{s,i;s′} represents a state transition probability of transition from the visible state, s to the visible state, s′ by the action a in the hidden state i and the visible state, s.

16. The method of claim 14, further comprising updating the probability distribution b over the hidden states by substituting, in the probability b(i) of the hidden state being i in response to the action selected, in accordance with the expression:
$$b ( i ) = \frac{b ( i ) {p}_{s , i ; {s}^{′} , z}^{a}}{{Σ}_{j ∈ B} b ( j ) {p}_{s , j ; {s}^{′} , z}^{a}}$$
wherein P^{a}_{s,i;s′,z} represents a state transition probability of transition from the visible state, s to the visible state, s′ and observation of an observation z by the action a in the hidden state i and the visible state, s.
